(19) United States
(12) Patent Application Publication
(10) Pub. No.: US 2009/0178243 A1
(43) Pub. Date: Jul. 16, 2009

(54) HANDLE

(76) Inventors: Mario FRANK, Hangzhou (CN); Ulrich MUELLER-BOYSEN, Esslingen (DE); Joachim SCHADOW, Dettenhausen (DE); Roswitha EICHER, Filderstadt (DE); Stefan HEESS, Leinfelden-Echterdingen (DE); Joerg MAUTE, Sindelfingen (DE); Juergen WIKER, Hangzhou (CN); Siegfried KEUSCH, Deizisau (DE); Florian ESENWEIN, Uhingen-Holzhausen (DE); Berbhard EICHER, Filderstadt (DE); Marcus SCHULLER, Dettenhausen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/046,801

(22) Filed: Mar. 12, 2008

(30) Foreign Application Priority Data
Mar. 12, 2007 (DE) 10 2007 011 787.8

(51) Int. Cl. B25G 1/10

(52) U.S. Cl. 16/421

(57) ABSTRACT

The invention describes a handle including a grip element and a fastening element, which are situated spaced apart from each other by at least one damping element; at least one of the contact surfaces of the grip element or fastening element, which are oriented toward each other via the damping element, is embodied as profiled so that the contact surface is enlarged.

### REFERENCE TO FOREIGN PATENT APPLICATION

This application is based on German Patent Application No. 10 2007 011 787.8 filed 12 Mar. 2007, upon which priority is claimed.

### BACKGROUND OF THE INVENTION

1. Field of the Invention

The invention relates to a handle, in particular an auxiliary handle, for a hand-guided power tool.

2. Description of the Prior Art

Numerous power tools such as angle grinders, drills, and rotary hammers are equipped with an auxiliary handle. In order to prevent vibrations generated during operation of the power tool from being transmitted to the operator, auxiliary handles are usually provided with vibration-damping means.

As described, for example, in DE 20 2004 012 400 U1, there are already known auxiliary handles in which an elastic intermediary element is provided as a vibration-damping means between a fastening part, which serves to mount the auxiliary handle onto the housing of a hand-guided power tool, and a grip region, which is designed to be grasped by the operator of the hand-guided power tool.

### OBJECT AND SUMMARY OF THE INVENTION

The present invention is based on a handle that includes a grip element and a fastening element for attaching the handle to a housing of a hand-guided power tool. So that vibrations during operation of the hand-guided power tool are not transmitted from the hand-guided power tool to the grip element of the handle or are only transmitted to a reduced degree, the grip element and the fastening element are spaced apart by at least one damping element Consequently the fastening element and the grip element do not touch each other directly, but only via at least one damping means.

In order to reduce vibrations in the handle as much as possible, according to the present invention, at least one of the two contact surfaces, i.e. the contact surface of the grip element or the contact surface of the fastening element, which are oriented toward each other via the damping element, is embodied as profiled so as to enlarge the contact surfaces. Preferably, both of the contact surfaces are profiled; the two contact surfaces can be profiled the same way or differently.

The expression “profiled contact surface” is understood to mean a contact surface that is not smooth in macroscopic terms, but instead has a certain roughness that is sufficient to significantly increase the surface area of the contact surface. In order to enlarge the contact surfaces of the grip element and fastening element, the contact surfaces are in particular provided with structural elements that result in a profiling or structuring of the contact surfaces. These structural elements can be grooves, ribs, beads, knobs, pins, teeth, or the like. These structural elements can be arranged regularly or irregularly.

The profiling of the contact surfaces produces an advantageous enlargement of the contact surfaces between the grip element and damping element and between the fastening element and damping element. It is therefore possible for the forces that occur to be favorably distributed over a large area, thus minimizing the danger of an overload of the damping element. In addition, due to its favorable material distribution, such an embodiment also experiences a high degree of vibration damping.

As structural elements, the contact surface of the grip element can be provided with claws and the contact surface of the fastening element can be provided with counterpart claws. The claws and counterpart claws reach between one another; they are situated spaced apart from one another and therefore do not directly touch. Between the claws and counterpart claws, a gap-shaped intermediate space is formed, into which the damping element, e.g. composed of an elastic material, is introduced. The claws and counterpart claws can be oriented axially in relation to the handle so that they reach between one another in an axial direction. The claws and counterpart claws can, however, also be oriented radially so that they reach between one another in a radial direction.

In another embodiment, the contact surfaces are profiled so that they engage with one another in a thread-shaped fashion. In this instance, structural elements in the form of grooves on the contact surfaces are embodied in a fashion similar to a thread. Thus, the contact surfaces of the grip element and fastening element are provided with a thread-like profile and the thread-like profiles of the two contact surfaces engage with one another like a thread and counterpart thread. The reciprocal engagement occurs in a contactless fashion since the contact surfaces are not permitted to touch one another directly, but rather only via a damping element. As the damping element, an elastic material, e.g. an elastomer, foam, or another vibration-absorbing material, can be injected in a thread-shaped form into the intermediate space between the grip element and fastening element.

Because of the profiling or structuring of the contact surfaces of the grip element and fastening element, the damping element is situated in a meandering or undulating form between the contact surfaces. It is particularly advantageous if the entire intermediate space between the contact surfaces is filled with a damping element. In addition to an elastomer or foam, the vibration-absorbing material for the damping element can also be provided in the form of a damping cushion filled with a fluid, e.g. a gas, a liquid, or a gel.

The grip element of the handle according to the present invention has an essentially cylindrical form. In a simple embodiment, it can be a cylinder. The cylindrical grip sleeve can also be adapted to the ergonomics of the human hand in that, by contrast with a purely cylindrical shape, it has varying diameters along its longitudinal axis, for example, and is thus bulbous or convex. The grip element here can be rotationally symmetrical so that the handle can be grasped at any orientation in relation to the operator. Alternatively, the grip element can also be especially adapted to the ergonomics of the human hand so that a first region of the grip element specifically serves as a support surface for the palm and a second region serves as a support surface for the fingers.

In addition, the grip element can be of a one-part or multipart embodiment. A multipart grip element is composed, for example, of a grip core and a grip casing, possibly with a damping element situated between them. One or more parts of the grip element can likewise be embodied as vibration-damping. Thus, for example, the grip casing can be composed of an elastic material, e.g. an elastomer or a foam, or the grip core can be embodied as an absorbing mass. The grip element can also have a coating composed of an elastic material.

The fastening element is used to detachably fasten the handle to a housing of a hand-guided power tool. In a simple embodiment, the fastening element can be a kind of threaded bolt that can be screwed into the housing of the hand-guided power tool. By contrast, the fastening element can be a kind of threaded nut or another type of recess with an internal thread, with the housing of the hand-guided power tool being provided with a corresponding thread for the attachment of the handle. In lieu of a screw connection device, the fastening element can also be provided, for example, in the form of a clamping device for attaching the handle to the housing of a hand-guided power tool.

The fastening element can be of a one-part or multipart embodiment. A two-part fastening element is composed, for example, of a fastening device and a support element; the fastening device can, for example, be a screw connection device, e.g. a threaded bolt, a screw, or the like, or can be a clamping device. The fastening device is supported on the support element, e.g. in that a threaded bolt is partially extrusion coated with plastic that constitutes the support element. The support element for the fastening device constitutes the head of the handle and is oriented toward the hand-guided power tool in the installed position of the handle on the housing of a tool. In such a two-part embodiment of the fastening element, the support element is situated spaced apart from the grip element and is connected to the grip element via a damping element.

The handle according to the present invention is particularly suited for use as an auxiliary handle for a cordless or corded hand-guided power toot such as an angle grinder or rotary hammer. Consequently, a hand-guided power tool that has a handle according to the present invention is also a subject of the present invention.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a first embodiment of a handle according to the present invention, with profiled contact surfaces in the form of claws and counterpart claws,

FIG. 2 shows a second embodiment of a handle according to the present invention, with profiled contact surfaces in the form of claws and counterpart claws, and

FIG. 3 shows another embodiment of a handle according to the present invention, with profiled contact surfaces in the form of threads and counterpart threads.

### DESCRIPTION OF THE PREFERRED EMBODIMENTS

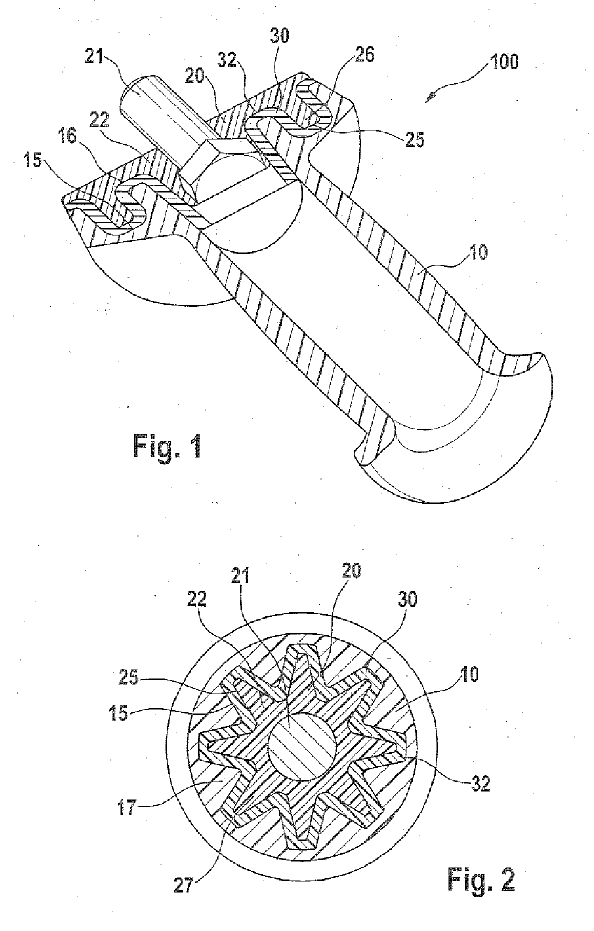

In a first embodiment schematically depicted in FIG. 1, the handle 100, which is particularly suited for use as an auxiliary handle for a hand-guided power tool (not shown), has a grip element 10, a fastening element 20, and a damping element 30. The grip element 10 and the fastening element 20 are situated spaced apart from each other by the damping element 30. Consequently, they do not touch each other directly, as a result of which vibrations during operation of the hand-guided power tool are transmitted from the hand-guided power tool to the grip element 10 only to a sharply reduced degree. The fastening element 20 according to FIG. 1 is composed of two parts, a support element 22 and a fastening device 21 in the form of a threaded bolt. The support element 22 can, for example, be composed of a plastic that is injection molded onto the fastening device; the head of the threaded bolt is contained in the support element 22 while the shaft with the threads (not shown) protrudes at least partway out from the support element 22. With the aid of the threaded bolt, the handle 100 can be screwed into a housing of a hand-guided power tool.

According to the present invention, in the handle 100, the contact surfaces of the grip element 10 and fastening element 20 are embodied as profiled. To that end, claws 16 are formed onto the contact surface 15 of the grip element 10 and counterpart claws 26 are formed onto the contact surface 25 of the fastening element 20. As shown in FIG. 1, the claws 16 and counterpart claws 26 reach between one another in a contactless fashion since they are situated spaced apart from one another by the damping element 30. The damping element 30, preferably composed of an elastic material such as elastomer or foam, is introduced into a gap-shaped intermediate space 32, which is formed between the grip element 10 and the support element 22 of the fastening element 20. In the longitudinal section according to FIG. 1, it is clear that the claws 16 and counterpart claws 26 are oriented in the axial direction in relation to the handle 100 and consequently reach between one another in the axial direction. In an alternative embodiment depicted cross-sectionally in FIG. 2, the claws 17 of the grip element 10 and the counterpart claws 27 of the fastening element 20 are oriented radially so that the claws 17 and counterpart claws 27 contactlessly reach between one another in the radial direction.

In both of the embodiments, the contact surfaces 15, 25 are significantly enlarged by the embodiment of claws 16, 17 and counterpart claws 26, 27.

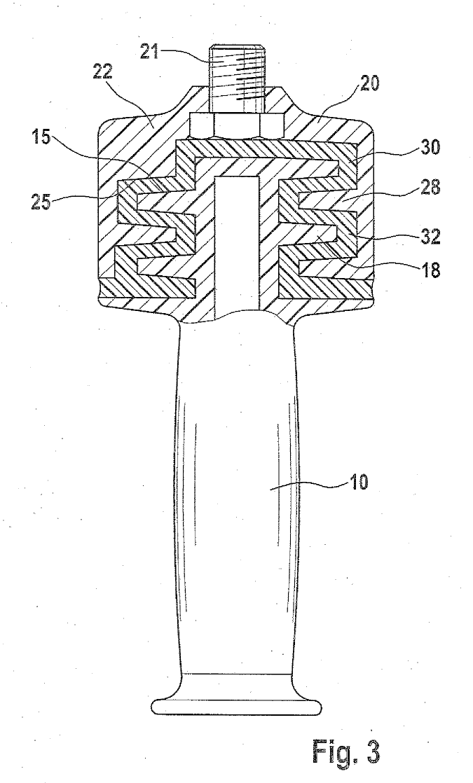

In another embodiment of profiled contact surfaces 15, 25 shown in FIG. 3, the contact surfaces 15, 25 are profiled so that they engage with one another in a thread-shaped fashion 18, 28. In this instance, the contact surfaces 15, 25 of the grip element 10 and fastening element 20 are provided with a thread-like profile and the thread-like profiles of the two contact surfaces 15, 25 engage with one another like a thread 18 and counterpart thread 28. The engagement is contactless since the contact surfaces 15, 25 do not touch each other directly but only indirectly by means of a damping element 30. The damping element 30 can be an elastic material such as an elastomer, foam, or another vibration-absorbing material that is injected in a thread-shaped form into the intermediate space 32 between the grip element 10 and fastening element 20.

As is clear from the drawings, due to the profiling or structuring of the contact surfaces 15, 25, the damping element 30 is situated in a meandering or undulating form between the contact surfaces 15, 25.

The foregoing relates to preferred exemplary embodiments of the invention, it being understood that other variants and embodiments thereof are possible within the spirit and scope of the invention, the latter being defined by the appended claims.

We claim:

1. A handle comprising a grip element, at least one damping element and a fastening element, the grip element and fastening element having opposed contact surfaces situated spaced apart from each other by the at least one damping element, and at least one of the contact surfaces of the grip element or fastening element, which are oriented toward each other and retained in spaced relation via the damping element, is embodied as profiled so that the contact surface is enlarged.

2. The handle as recited in claim 1, wherein the contact surface of the grip element and the contact surface of the fastening element are embodied as profiled.

3. The handle as recited in claim 1, wherein claws are embodied on the contact surface of the grip element and counterpart claws are embodied on the contact surface of the fastening element, and wherein the claws and counterpart claws reach between one another and the contact surfaces are situated spaced apart from one another.

4. The handle as recited in claim 2, wherein claws are embodied on the contact surface of the grip element and counterpart claws are embodied on the contact surface of the fastening element, and wherein the claws and counterpart claws reach between one another and the contact surfaces are situated spaced apart from one another.

5. The handle as recited in claim 3, wherein the claws and counterpart claws are axially oriented so that they reach between one another in the axial direction.

6. The handle as recited in claim 4, wherein the claws and counterpart claws are axially oriented so that they reach between one another in the axial direction.

7. The handle as recited in claim 3, wherein the claws and counterpart claws are radially oriented so that they reach between one another in the radial direction.

8. The handle as recited in claim 4, wherein the claws and counterpart claws are radially oriented so that they reach between one another in the radial direction.

9. The handle as recited in claim 1, wherein the contact surfaces are embodied as profiled in such a way that they engage with one another in a thread-shaped fashion.

10. The handle as recited in claim 2, wherein the contact surfaces are embodied as profiled in such a way that they engage with one another in a thread-shaped fashion.

11. The handle as recited in claim 3, wherein the contact surfaces are embodied as profiled in such a way that they engage with one another in a thread-shaped fashion.

12. The handle as recited in claim 5, wherein the contact surfaces are embodied as profiled in such a way that they engage with one another in a thread-shaped fashion.

13. The handle as recited in claim 7, wherein the contact surfaces are embodied as profiled in such a way that they engage with one another in a thread-shaped fashion.

14. The handle as recited in claim 1, wherein the contact surfaces are embodied as profiled in such a way that the damping element is situated in a meandering form between the contact surfaces.

15. The handle as recited in claim 2, wherein the contact surfaces are embodied as profiled in such a way that the damping element is situated in a meandering form between the contact surfaces.

16. The handle as recited in claim 3, wherein the contact surfaces are embodied as profiled in such a way that the damping element is situated in a meandering form between the contact surfaces.

17. The handle as recited in claim 5, wherein the contact surfaces are embodied as profiled in such a way that the damping element is situated in a meandering form between the contact surfaces.

18. The handle as recited in claim 7, wherein the contact surfaces are embodied as profiled in such a way that the damping element is situated in a meandering form between the contact surfaces.

19. The handle as recited in claim 1, wherein the damping element is composed of an elastic material, in particular an elastomer.

20. A hand-guided power tool equipped with a handle as recited in claim 1.
